(19) United States
(12) Patent Application Publication
(10) Pub. No.: US 2018/0130153 A1
(43) Pub. Date: May 10, 2018

(54) SYSTEM AND METHOD FOR DETECTING AND CORRECTING INCOMPLETE DATA ASSOCIATED WITH A PROJECT, TRANSACTION OR BUSINESS PROCESS

(71) Applicants: James A. NIELSEN, Scottsdale, AZ (US); Juan LORENZANA, Peoria, AZ (US); Mark DIABROSIO, Phoenix, AZ (US); Tom BLOOMER, Scottsdale, AZ (US)

(72) Inventors: James A. NIELSEN, Scottsdale, AZ (US); Juan LORENZANA, Peoria, AZ (US); Mark DIABROSIO, Phoenix, AZ (US); Tom BLOOMER, Scottsdale, AZ (US)

(21) Appl. No.: 15/787,518

(22) Filed: Oct. 18, 2017

Related U.S. Application Data
(60) Provisional application No. 62/409,844, filed on Oct. 18, 2016.
(60) Provisional application No. 62/409,927, filed on Oct. 19, 2016.

(51) Int. Cl. G06Q 50/18; G06Q 50/08; G06F 11/30; G06Q 10/10; G06F 17/30

(52) U.S. Cl. CPC G06Q 50/18; G06Q 50/08; G06F 17/30011; G06Q 10/103; G06F 17/30312; G06F 11/3089

(57) ABSTRACT

A system for and method of detecting and correcting incomplete data associated with a project is provided. The system includes a graphic module for creating a graphic output. The graphic output includes a plurality of inter-connected nodes, each node representing a party and each connection representing a relationship between the parties. The first node represents a property owner. In this way, the graphic output provides a visual indication of incomplete data if one or more node is not connected, directly or indirectly, to the first node. The system further includes a table module for creating one or more output table. The output table includes first and second groups of cells representing parties, the first and second groups of cells being positioned relative to each other so as to represent a relationship between the parties. The output table provides a visual indication if data is incomplete.

### CROSS-REFERENCE TO RELATED APPLICATIONS

This application claims priority pursuant to 35 U.S.C. 119(e) to co-pending U.S. Provisional Patent Application Ser. No. 62/409,844, filed Oct. 18, 2016, and 62/409,927, filed Oct. 19, 2017, the entire disclosures of which are incorporated herein by reference. Furthermore, this application incorporates by reference the entire disclosures of the following: U.S. Non-provisional application Ser. No. 14/971,762, filed Dec. 16, 2015, which claims priority to then co-pending U.S. Provisional Patent Application Ser. No. 62/092,575, filed Dec. 16, 2014, and is a continuation-in-part of co-pending U.S. Non-provisional application Ser. No. 13/856,890, filed Apr. 4, 2013, which claims priority to U.S. Provisional Patent Application Ser. No. 61/620,323, filed Apr. 4, 2012, and is a continuation-in-part of co-pending U.S. Non-provisional application Ser. No. 12/803,690, filed Jul. 2, 2010, which is a continuation-in-part of application Ser. No. 10/072,552, filed Feb. 7, 2002, which claims priority to U.S. Provisional Application No. 60/266,986, filed Feb. 7, 2001.

### FIELD

The present invention relates generally to systems and methods of detecting and correcting incomplete data associated with a project, transaction, or business process. More specifically, in some embodiments, the invention relates to a unique system and method of detecting an incomplete set of lien notices associated with a construction project, and for presenting the project owners a project graph for identification and correction of the incomplete information. In some embodiments, the system is a subcomponent of a larger system.

### BACKGROUND

During construction and/or renovation projects, builders, contractors, subcontractors, owners, or even lessees, often require credit to purchase building materials and/or to pay Service Providers (such as brick layers, masonry, plumbers, engineers, surveyors, architects, etc.). Various other consumer transactions and business to business transactions also require credit. In many cases, the credit is obtained through a supplier credit account and/or from a third party, such as a credit card company.

To offset some of the risks associated with supplier credit accounts, suppliers of construction materials and services may obtain “credit default swap” insurance. Under the terms of a traditional credit default swap insurance policy, the policy is obtained based upon a loan to a third party debtor that has already been made prior to obtaining the insurance coverage, and an insurer reimburses a creditor if the third-party debtor defaults on the loan. Upon reimbursing the creditor for the third-party's debt, the insurer obtains the right to collect the debt from the debtor.

Suppliers of construction materials and services traditionally have been more willing to extend credit to its customers due to potential lien rights, including but not limited to mechanics lien rights, that often attach to such sales. Furthermore, insurers are more likely to offer favorable credit default swap insurance terms when the insured debt is secured by a lien. (Lien rights may be called many different names depending upon the statute, material, or service provided. For brevity within this application, all lien rights that material suppliers or Service Providers provide will hereinafter be referenced as “mechanics lien”.)

A mechanics lien provides protection to a party that supplies materials or labor to an improvement of real property (referred to herein as a “building improvement” or “improvement”). The lien rights attach directly to the building/property enhanced by the lien holder's materials or services. Thus, a properly perfected mechanics lien enables a supplier, or an insurer, (each a “lien claimant”) to collect on unpaid accounts directly from the property owner in the event of a default in payment from the supplier's actual customer (i.e. a contractor, subcontractor, or other service provider that purchased materials or services for the improvement of real property, each a “lien debtor”).

In many states, a potential lien claimant is required to provide a property owner with notice of potential mechanics lien (a “preliminary lien notice”). With sufficient notice, a property owner can take steps to ensure that a lien debtor pays its debt to a potential lien claimant. Unfortunately, property owners do not always have sufficient information associated with a project. For instance, property owners often hire a general contractor to complete a project, such as building a structure on an undeveloped piece of land or building a new addition to or remodeling a pre-existing structure. The general contractor then hires one or more subcontractors and/or Service Providers (each a “subcontractor”) and sometimes a subcontractor then hires its own subcontractor. Furthermore, the general contractor and/or one or more subcontractor may purchase materials from various material suppliers. Many such subcontractors and/or material suppliers are entitled to mechanics lien rights in the property, through contract law or otherwise.

The various multiple possible mechanics lien rights are difficult for the owner to track. In most cases, the property owner has contracted with one party only, the general contractor, or in some cases very few parties. In many cases, the owner does not know all of the various multiple possible subcontractors and material suppliers who may be entitled to mechanics lien rights. It is difficult for the owner to track the relationships between the various multiple possible subcontractors and material suppliers, to verify legitimate mechanics liens, and to ensure that the appropriate parties are paid the appropriate amounts within appropriate timeframes. In many cases, the owner learns about one of the various multiple possible subcontractors or material suppliers for the first time when it learns of a preliminary lien notice. The preliminary lien notice, however, typically does not identify the relationship of the parties in the preliminary lien notice to the property or the property owner.

Accordingly, it would be highly desirable to provide systems and methods of detecting and correcting incomplete data associated with a project. It would be further desirable for the system to utilize information from preliminary lien notices associated with a project to assist the owner of the property to detect and correct incomplete or missing data such as various multiple possible subcontractors or material suppliers and their respective contractual relationship to the property owner, eventually, through various intermediaries. Notwithstanding, one having ordinary skill in the art will recognize that various embodiments of the present inventive concept are capable of being applied in other contexts and situations where detecting and correcting incomplete data associated with a project, transaction, or business process is desirable.

### SUMMARY

It is an object of the instant invention to provide systems and methods of detecting and correcting incomplete data associated with a project. Various examples of the present inventive concept enable a property owner using data from preliminary lien notices to detect and correct incomplete data relating to various multiple possible subcontractors or material suppliers.

In some embodiments, a property owner can use the present inventive concept to create a graphical representation, chart or table of the various multiple possible subcontractors or material suppliers and their respective contractual relationship to one another and to the property owner, eventually, through various intermediaries by using the data compiled from preliminary lien notices. A database is created from the preliminary lien notices. The database includes each of the contracting parties and their respective relationships to one another. Each party is either a claimant or has contracted with a claimant. When the “contracted-with” party is not the property owner, a new relationship is created to suggest to the owner an incomplete data set where the “contracted-with” party has a relationship, either directly or indirectly, with the property owner. The owner has an option to fill-in the missing data to complete the relationship of the “contracted-with” party.

In some embodiments, the system includes a user interface for entering data from preliminary lien notices. In some such embodiments, the computer software program of the present inventive concept detects incomplete data associated with the input data. The user can then correct the incomplete data.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

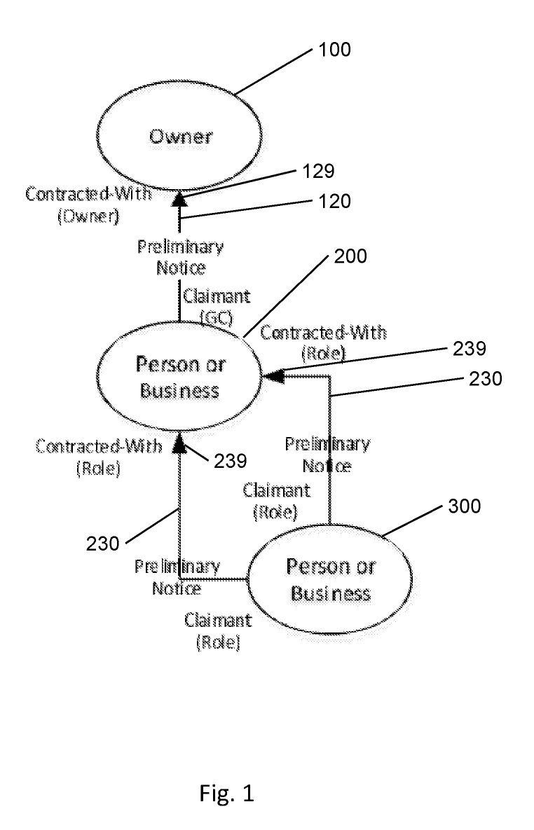

FIG. 1 is a graphic representation of a generic graphic output of a system of the present invention, the graphic output showing a second node connected directly to a first node and a second node connected indirectly to the first node.

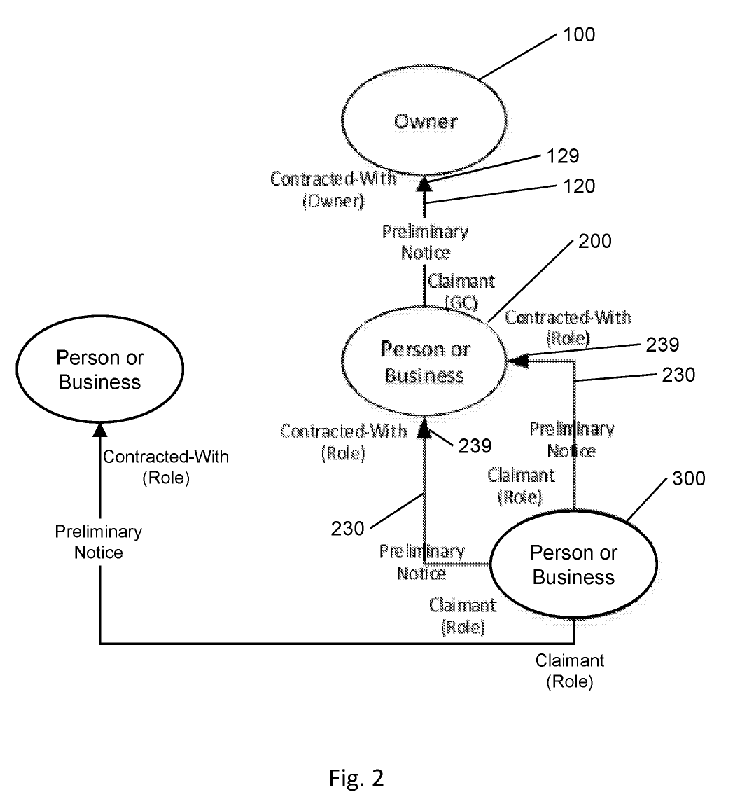

FIG. 2 is a graphic representation of a generic output of a system of the present invention, the graphic output showing a fourth node that is not connected to a first node.

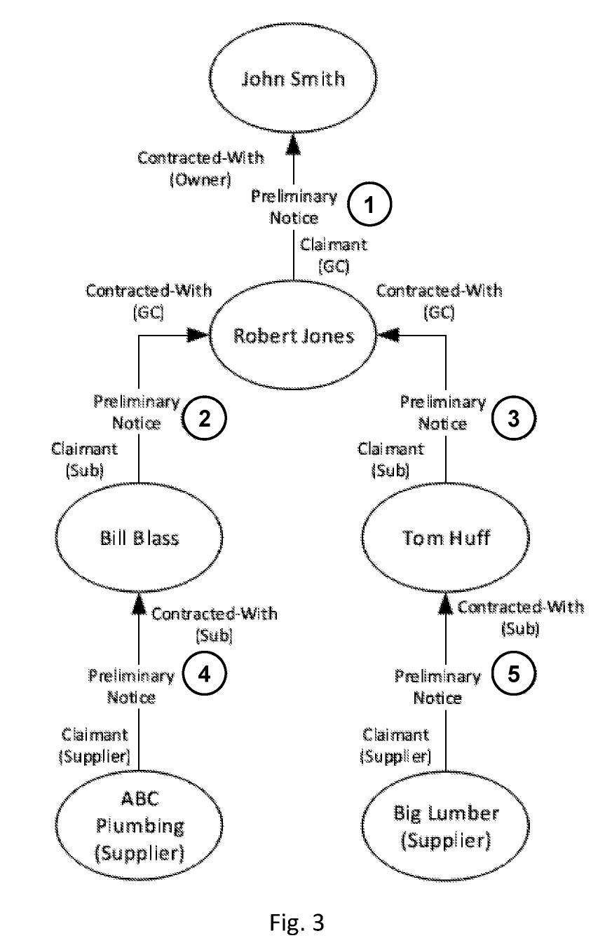

FIG. 3 is a graphic representation of a specific graphic output of a system of the present invention, the graphic output showing second, third, fourth, fifth, and sixth nodes each being connected, directly or indirectly, to a first node.

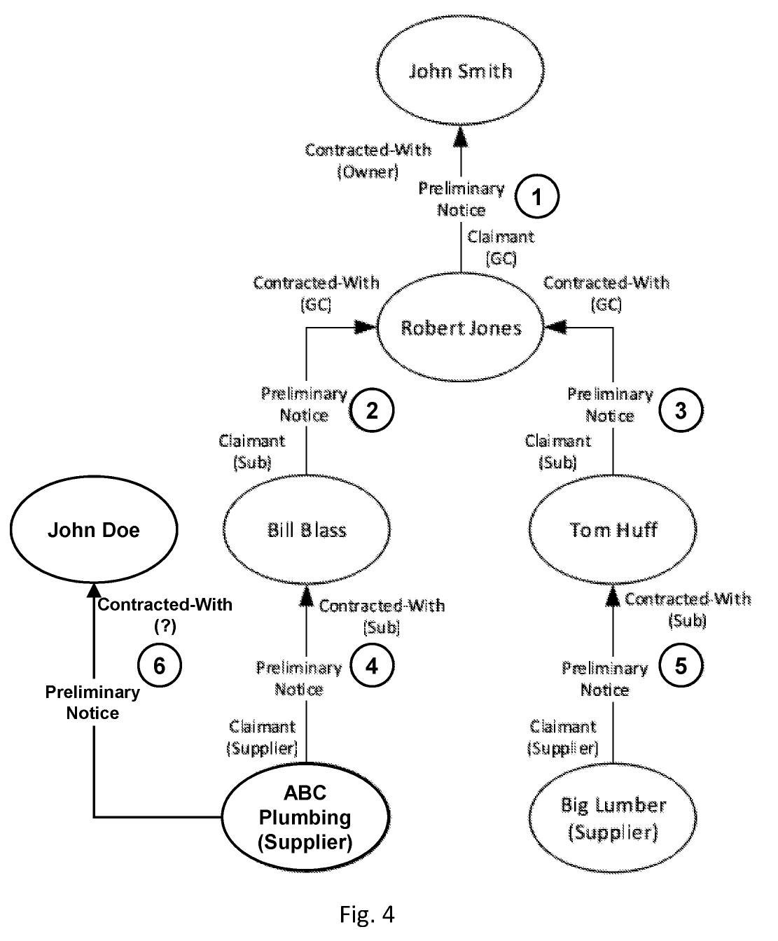

FIG. 4 is a graphic representation of a specific graphic output of a system of the present invention, the graphic output showing a seventh node that is not connected to a first node.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Some embodiments of the present invention include a graphic module for creating one or more graphic output. Referring to FIG. 1, some embodiments of graphic outputs include a first node 100 representing a first party, such as a property owner, a second node 200 representing a second party, such as a general contractor, and a third node 300 representing a third party, such as a subcontractor and/or material supplier. In some embodiments, a graphic output includes one or more additional nodes to represent one or more additional parties. In some embodiments, two or more nodes represents a single party, such as to more accurately reflect a party's various relationships with various other parties.

In some embodiments, the graphic output includes a first connector 120 extending between the first 100 and second 200 nodes and a second connector 230 extending between the second 200 and third 300 nodes. In some embodiments, the first connector 120 is a visual representation of a relationship between the first and second parties. In some embodiments, the second connector 230 is a visual representation of a relationship between the second and third parties. In some embodiments, a graphic output includes one or more additional connectors extending between two nodes, thereby representing an additional relationship. In some embodiments, one node is connected to another node with a plurality of connectors, thereby representing a plurality of relationships between the parties associated with the respective nodes. In some embodiments, one node is connected to a plurality of other nodes, thereby representing relationships with a plurality of other parties.

In some embodiments, the graphic output includes a plurality of text identifiers for identifying one or more party and/or one or more relationship of a party to another party. In some embodiments, one or more text identifier is associated with one or more node, thereby identifying a name or position of one or more party, such as the first party, the second party, and/or the third party. In some embodiments, the text identifier identifies the first party as a property owner, the second party as a general contractor, and the third party as a subcontractor, such as a subcontracting service provider, and/or a material supplier.

In some embodiments, one or more text identifier is associated with a connector, thereby providing information associated with the respective relationship. In some such embodiments, the text identifier indicates that one of the parties has provided a preliminary lien notice or some other lien notice (a “lien notice”) to the other party and/or based on rights obtained through and/or in association with an agreement or course of dealings with the other party. In some such embodiments, the text identifier is also associated with a node, thereby identifying a role of a respective party and/or another association of the respective party to the other party and/or the relationship between the parties. In some embodiments, the text identifier indicates whether the party is a claimant (or potential claimant) and/or whether the party is associated with one or more lien notice.

Still referring to FIG. 1, some embodiments of graphic outputs include first 129 and/or second 239 indicators associated with respective first 120 and/or second 230 connectors. In some embodiments, the first indicator 129 provides a visual representation of a type of relationship between the first and second parties. In some such embodiments, the first indicator 129 is an arrowhead pointed at the first node, thereby indicating that the second party has contracted with the first party and/or that the second party is a claimant (or potential claimant) in association with services and/or materials provided (directly or indirectly) by the second party. In some embodiments, the second indicator 239 provides a visual representation of a type of relationship between the second and third parties. In some such embodiments, the second indicator 239 is an arrowhead pointed at the second node, thereby indicating that the third party has contracted with the second party and/or that the third party is a claimant (or potential claimant) in association with a services and/or materials provided (directly or indirectly) by the third party.

Some embodiments of the present invention include a table module for creating one or more output table. In some embodiments, the present invention provides an output table in lieu of and/or in addition to a graphic output. In some embodiments, the table of information includes a row or column of data associated with each relationship. In some embodiments, the graphic output includes one or more identifier for associating one or more relationship graphically represented by the graphic output with one or more row or column of information provided by the output table. In some embodiments, the output table includes information pertaining to each relationship and/or information pertaining to one or more party of one or more relationship. In some embodiments, the output table provides one or more indication of whether there is incomplete information associated with one or more relationship and/or party.

FIG. 3 shows an example of a graphic output of the present invention showing traceability of each relationship back to the property owner, as further indicated by the following table:

| | | | | Con- | | |
|---|---|---|---|---|---|---|
| | | | 100% | tracted- | | 100% |
| Prelien | Claimant | Role | Match | With | Role | Match |
| 1 | Robert | GC | Y | John | Owner | Y |
| | Jones | | | Smith | | |
| 2 | Bill Blass | Sub | Y | Robert Jones | GC | Y |
| 3 | Tom Huff | Sub | Y | Robert Jones | GC | Y |
| 4 | ABC | Supplier | Y | Bill Blass | Sub | Y |
| | Plumbing | | | | | |
| 5 | Big | Supplier | Y | Tom Huff | Sub | Y |
| | Lumber | | | | | |

FIG. 4 shows an example of a graphic output of the present invention showing traceability of some relationships back to the property owner, as further indicated by the following table:

| | | | | Con- | | |
|---|---|---|---|---|---|---|
| | | | 100% | tracted- | | 100% |
| Prelien | Claimant | Role | Match | With | Role | Match |
| 1 | Robert | GC | Y | John | Owner | Y |
| | Jones | | | Smith | | |
| 2 | Bill Blass | Sub | Y | Robert Jones | GC | Y |
| 3 | Tom Huff | Sub | Y | Robert Jones | GC | Y |
| 4 | ABC | Supplier | Y | Bill Blass | Sub | Y |
| | Plumbing | | | | | |
| 5 | Big | Supplier | Y | Tom Huff | Sub | Y |
| | Lumber | | | | | |
| 6 | ABC | Supplier | Y | John Doe | ? | N |
| | Plumbing | | | | | |

In some embodiments, the system includes one or more table of general contractors, subcontractors, and/or material suppliers (each a “system contact”). In some such embodiments, the system includes a comparison module for comparing information from one or more preliminary lien notice with information associated with one or more system contact. In some such embodiments, the comparison module provides one or more indication of whether preliminary lien notice information matches system contact information. In some embodiments, the indication is provided in association with a graphic output and/or an output table. In some embodiments, the indication assists a user in determining how closely the information matches, thereby giving the user an indication of the reliability of the information. In this way, the system detects potential incomplete or erroneous information and assists users in identifying the same, thereby assisting users in completing and/or correcting information.

Various embodiments of the computer program, devices, systems, and methods of the present invention are implemented in hardware, software, firmware, or combinations thereof using central management system (e.g. TCS or other central computer control system) of the invention, which broadly comprises server devices, computing devices, a communications network, and a data discussed above (account number, project ID, etc.). Various embodiments of the server devices include computing devices that provide access to one or more general computing resources, such as Internet services, electronic mail services, data transfer services, and the like. In some embodiments the server devices also provides access to a database that stores information and data, with such information and data including, without limitation, system user information (e.g. project ID, account number, etc.), information regarding contractors, subcontractors, suppliers, liens, or the like, or other information and data necessary and/or desirable for the implementation of the computer program, devices, systems, and methods of the present invention.

Various embodiments of the server devices and the computing devices include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard disk drives, network attached storage, or a separate storage network.

Various embodiments of the computing devices specifically include mobile communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device includes an optical device such as a digital camera, video camera, optical scanner, or the like, such that the computing device can capture, store, and transmit digital images and/or videos, bar codes or other identification information.

In some embodiments the computing devices includes a user control interface that enables one or more users to share information and commands with the computing devices or server devices. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of the computer program of the present invention run on computing devices. In other embodiments the computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments information is stored on a memory element associated with the server device, such that the information is remotely accessible to users of the computer program via one or more computing devices. Alternatively, in other embodiments the information is directly stored on the memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using the computer program will actually be performed by one or more computers, processors, or other computational devices, such as the computing devices and/or server devices, independently or cooperatively executing portions of the computer program.

A user is capable of accessing various embodiments of the present invention via an electronic resource, such as an application, a mobile “app,” or a website. In certain embodiments, portions of the computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the Internet) with the computing device.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, various embodiments of the present technology include a variety of combinations and/or integrations of the embodiments described herein.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A system for detecting incomplete or erroneous data associated with a project, the system comprising:
a database for storing information;
a processor for processing information; and
a graphic module that is configured to create a graphic output comprising:
a plurality of nodes, each node representing a party; and
a plurality of connectors, each connector extending between a pair of nodes so as to represent a relationship between the parties,
wherein a first node represents a first party, the first party being an owner of a property,
wherein a second node represents a second party, the second party being a contractor associated with a project for the property,
wherein a third node represents a third party, the third party being one of a subcontractor or a material supplier of the contractor,
wherein the third party has provided goods or services on credit in association with the property such that the third party has a right to file a mechanics lien against the property if not repaid, and
wherein the third party's right to file a mechanics lien against the property is not derived from any agreement with or course of dealings between the third party and the property owner.

2. The system of claim 1, wherein the graphic output comprises a first indicator associated with a first connector extending between the first and second node, the first indicator providing an indication that the second party is a claimant in association with services or materials provided directly or indirectly by the second party.

3. The system of claim 1, wherein the system is configured to extract information from a digital preliminary lien notice, and wherein the graphic output is created using information extracted from the digital preliminary lien notice.

4. The system of claim 1, wherein the system includes a user interface for allowing a user to input information into the system, the inputted information being obtained from one or more lien notice, and wherein the graphic output is created using information input by the user.

5. The system of claim 4, wherein the system is configured to extract information from a digital preliminary lien notice, and wherein the graphic output is created using information extracted from the digital preliminary lien notice.

6. The system of claim 1, wherein the graphic output provides one or more indication that a property owner has incorrect or incomplete information pertaining to one or more preliminary lien notice.

7. The system of claim 6, wherein the indication is a node that is not connected to the first node, either directly or indirectly.

8. The system of claim 1, further comprising a table module for creating an output table, the output table comprising:
a first group of cells identifying a plurality of parties; and
a second group of cells identifying a plurality of parties,
wherein the first and second group of cells are positioned relative to each other so as to represent a relationship between the parties.

9. The system of claim 8, wherein the output table provides one or more indication that a property owner has incorrect or incomplete information pertaining to one or more preliminary lien notice.

10. The system of claim 9, wherein the indication is a highlighted cell.

11. The system of claim 8, wherein the output table includes a third group of cells associated with the graphic output, the third group of cells being positioned relative to each of the first and second group of cells.

12. The system of claim 11, wherein the graphic output includes a plurality of unique identifiers, each unique identifier being associated with a different connector, and wherein the third group of cells includes the unique identifiers.

13. The system of claim 8, wherein:
a first cell of the first group of cells identifies the first party;
a first cell of the second group of cells and a second cell of the first group of cells each identify the second party;
a second cell of the second group of cells identifies the third party; and
the first and second cells of the first group of cells are associated with respective first and second cells of the second group of cells.

14. A system for detecting incomplete or erroneous data associated with a project, the system comprising:
a database for storing information;
a processor for processing information; and
a table module that is configured to create an output table comprising:
a first group of cells identifying a plurality of parties; and
a second group of cells identifying a plurality of parties,
wherein the first and second group of cells are positioned relative to each other so as to represent a relationship between the parties,
wherein a first cell of the first group of cells identifies a first party, the first party being an owner of a property,
wherein a first cell of the second group of cells and a second cell of the first group of cells each identify a second party, the second party being a contractor associated with a project for the property,
wherein a second cell of the second group of cells identifies a third party, the third party being one of a subcontractor or a material supplier of the contractor,
wherein the first and second cells of the first group of cells are associated with respective first and second cells of the second group of cells,
wherein the third party has provided goods or services on credit in association with the property such that the third party has a right to file a mechanics lien against the property if not repaid, and
wherein the third party's right to file a mechanics lien against the property is not derived from any agreement with or course of dealings between the third party and the property owner.

15. The system of claim 14, wherein the output table provides one or more indication that a property owner has incorrect or incomplete information pertaining to one or more preliminary lien notice.

16. The system of claim 15, wherein the indication is a highlighted cell.

17. The system of claim 15, wherein the indication is a blank cell.

18. The system of claim 17, wherein the indication is provided within a third group of cells, the third group of cells being positioned relative to each of the first and second group of cells.

19. A method of correcting incomplete data associated with a project, the method comprising:
utilizing the system of claim 1 to create a graphic output; and
analyzing the graphic output to determine completeness of data represented.

20. The method of claim 19, wherein the system of claim 1 further comprises the table module of claim 8, the method further comprising:
utilizing the system to create an output table; and
analyzing the output table to determine completeness of data represented.
